(19) United States
(12) Patent Application Publication
(10) Pub. No.: US 2025/0107555 A1
(43) Pub. Date: Apr. 3, 2025

(54) UNIQUE BLEND OF PLANT-DERIVED COMPONENTS IN DRINKING WATER TO SUPPORT PIGLETS

(71) Applicant: CAN TECHNOLOGIES, INC., Wayzata, MN (US)

(72) Inventors: Tobias Manfred AUMILLER, Altenberg bei Linz (AT); Jolie Caroline GONZALEZ VEGA, Bristol, TN (US); Janis Hendrik MAHNKEN, Linz (AT); Karola Renate WENDLER, St. Peter am Wimberg (AT)

(73) Assignee: CAN TECHNOLOGIES, INC., Wayzata, MN (US)

(21) Appl. No.: 18/901,219

(22) Filed: Sep. 30, 2024

Related U.S. Application Data
(60) Provisional application No. 63/587,597, filed on Oct. 3, 2023.

(51) Int. Cl. A23K 50/60; A23K 10/30; A23K 50/30

(52) U.S. Cl. CPC A23K 50/60; A23K 10/30; A23K 50/30

(57) ABSTRACT

Phytogenic compositions with an essential oil core and one or more additives are added to drinking water to support post-weaning (PW) piglets. The PW piglets provided drinking water supplemented with the phytogenic compositions have reduced mortality rates in a nursery. The essential oil core includes two essential oils. The two essential oils are eugenol and tea tree oil.

### CROSS-REFERENCE TO RELATED APPLICATIONS

This application claims the benefit of U.S. Provisional Application No. 63/587,597, filed Oct. 3, 2023, which is incorporated by reference herein in its entirety.

### FIELD

This disclosure relates to feeding piglets and more particularly relates to plant-derived compositions provided in drinking water to post-weaning piglets.

### BACKGROUND

Post-weaning diarrhea (PWD) is a problem swine producers face worldwide, and it is characterized by diarrhea, dehydration, mortality, and growth retardation in surviving pigs. The impact ranges from mild reductions in the growth performance to severe weight loss and mortality. An etiological agent commonly associated with PWD are pathogenic strains of enterotoxin producing Escherichia coli.

Many factors, including husbandry, environment, nutrition, and genetic susceptibility, play a critical role in the severity of this syndrome. Therefore, the control of PWD usually has to be approached at different levels: husbandry practices at the sow farms and nursery sites with proper sanitation and vaccination programs; minimize the stress after weaning by providing a fresh and easily accessible feed and water and an adequate environment (temperature and humidity) and space to the newly weaned pigs.

Management of nutritional programs is also an essential aspect of controlling PWD. Conventional swine production systems rely on the in-feed application of antibiotics, pharmacological levels of zinc, fiber, high digestible protein, spray-dried plasma, dietary acidification, functional feed additives, and others to help the newly weaned pigs to overcome post-weaning challenges. Antibiotics and other in-feed antimicrobial growth promoters such as zinc oxide are phased out more and more globally due to rising concerns regarding the development of bacterial resistances to clinically important antibiotic and accumulation in manure and the environment. Therefore, regulatory provisions, combined with an increasing pressure of consumers demanding more “natural” solutions, necessitates the search for alternatives to traditional antimicrobial growth promoters (AGPs) to maintain efficient farming in the future. Especially, promising in this regard are plant-derived bio-active compounds (hereinafter referred to as phytogenics).

### SUMMARY

PWD is a syndrome affecting piglets with a major impact on welfare, growth performance and cost efficacy of swine production. The present description relates to a unique blend of plant-derived components provided in drinking water to support post-weaning (PW) piglets. Without being bound by theory, it is thought that the plant-derived components can interact specifically with the intestinal tract and its microbiome, targeting microorganisms to reduce pathogenicity and increasing intestinal barrier integrity. Bacteria such as pathogenic E. coli, an etiological agent most commonly associated with PWD, are influenced in their ability to express virulence factors or invade intestinal epithelia. Successful prevention of pathogenicity supports reduced mortality, improved animal welfare and may provide antibiotic free management of livestock production.

The present description relates to modern livestock production methods to support piglets during the critical PW period. The methods and compositions described herein therefore are part of modern health and nutrition management strategies to support piglets during the critical weaning period.

In one aspect, the present disclosure provides a method of production of livestock animals in a nursery The method includes providing a phytogenic composition in drinking water to post-weaning piglets, wherein the phytogenic composition comprises an essential oil core, and one or more additives, e.g., maltodextrin. The essential oil core comprises essential oils, wherein the essential oils comprise eugenol and tea tree oil. The PW piglets provided the phytogenic composition in the drinking water have improved nursery performance relative to PW piglets provided the drinking water without the phytogenic composition. The improved performance comprises a reduced mortality rate during the post-weaning period of the PW piglet lifecycle.

In another aspect, the present disclosure provides a phytogenic drinking water composition comprising drinking water and a phytogenic composition, wherein the phytogenic composition comprises essential oils, wherein PW piglets in a nursery provided drinking water with the phytogenic composition have a reduced mortality rate relative to PW piglets provided drinking water without the phytogenic composition.

In yet another aspect, the present disclosure provides a phytogenic composition comprising an essential oil core and one or more additives, wherein the essential oil core comprises essential oils, wherein the essential oils comprise eugenol between about 5% by weight and about 15% by weight of the phytogenic composition and tea tree oil between about 5% by weight and about 15% by weight of the phytogenic composition. Preferably, the phytogenic composition further comprises one or more additives. The one or more additives may comprise maltodextrin. Preferably, the essential oils are microencapsulated with an encapsulation matrix.

### BRIEF DESCRIPTION OF THE DRAWINGS

This patent or application contains at least one drawing executed in color. Copies of this patent or patent application publication with color drawings will be provided by the Office upon request and the payment of the necessary fee.

The drawings illustrate generally, by way of example, but not by way of limitation, various aspects discussed herein.

FIG. 1 is a schematic diagram of one exemplary formulation of an essential oil composition.

FIG. 2A is a plot of amount of water disappearance (gallons/pig) between day 5 and day 21 of the post-weaning period of the PW piglets.

FIG. 2B is a plot of dilution ratio of medicator (stock solution used/water disappearance) between day 5 and day 21 of the post-weaning period of the PW piglets.

FIG. 3A is a plot of amount of product intake (mL/pig/day) between day 5 and day 21 of the post-weaning period of the PW piglets.

FIG. 3B is a plot of percent of product intake between day 5 and day 21 the post-weaning period of the PW piglets.

FIG. 4A is a plot of the timing of removals from all pens (average size and small PW piglet pens). The cumulative percentage of removals during the post-weaning period is shown.

FIG. 4B is a plot of the timing of removals from all pens (average size and small PW piglet pens). The cumulative number of removals during the post-weaning period is shown.

FIG. 4C is a plot of the timing of removals from the average size pig pens (without the small pig pens). The cumulative number of removals during the post-weaning period is shown.

FIG. 5A is a plot of the timing of closeout mortalities (at day 36 or treatment) for all pens (average size, small PW piglet pens and removal pig mortalities). The cumulative percentage of mortalities during the post-weaning period is shown.

FIG. 5B is a plot of the timing of closeout mortalities (at day 36 or treatment) for all pens (average size, small PW piglet pens and removal pig mortalities). The cumulative number of mortalities during the post-weaning period is shown.

FIG. 5C is a plot of the timing of closeout mortalities (at day 36 or treatment) from the average size pig pens (without the small pig pens). The cumulative number of mortalities during the post-weaning period is shown.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

The present disclosure relates to a method of production of livestock animals. The method improves the performance of piglets in a nursery during the PW period. The method includes providing a phytogenic composition in drinking water. The drinking water is supplemented with the phytogenic composition at the disclosed inclusion rates The PW piglets are provided the phytogenic composition during the post-weaning period to improve performance. The method can improve performance by a reduction of the mortality rate in the nursery. The method may also improve performance by reducing the morbidity rate, by reducing disease during the PW phase, e.g., post-weaning diarrhea (PWD), enhancing the growth, enhancing the health of the PW piglets or combinations thereof.

In the methods described herein, the PW piglets may have reduced severity of PWD symptoms, i.e., diarrhea, dehydration, mortality, and growth retardation in surviving pigs. Improved performance, animal welfare and reduced need for medication may be the direct effects when providing the phytogenic drinking water described herein to piglets during the post-weaning period. Without being bound by any theory, the phytogenic compositions provided in the drinking water may improve the welfare of the animals by supporting the development of a normal and functional gut, supporting their resilience against stress factors.

In one aspect, the phytogenic composition comprises an essential oil core, preferably a microencapsulated essential oil core. The essential oil core includes an essential oil, preferably a mixture of essential oils. Preferably, the essential oils include at least two essential oils at the disclosed percentages and/or ratios. In one aspect, the mixture of essential oils comprises eugenol and tea tree oil. One or more of the essential oils may be microencapsulated. Microencapsulation may be performed prior to combining the essential oils or after combining the essential oils. The phytogenic composition may further comprise one or more additives, for example, maltodextrin.

The term “post-weaning piglets” or “PW piglets” as used herein relates to the period from weaning of piglets until the start of the fattening stage. The PW piglet is at least 10 days old, preferably at least 15 days old, preferably at least 17 days old, preferably at least 21 days old, preferably at least 23 days old, more preferably between 21 days and 25 days old at the initiation of the method described herein. The feeding method may also be initiated when the PW piglets are older than 25 days old. It will be understood that the exact day of weaning can vary and post-weaning refers to any day of life after the piglet weaning is initiated and continues until the start of the fattening phase. The terms “PW phase”, “PW stage” and “PW period” are used interchangeably.

The PW phase comprises 3 phases. The term “phase 1” as used herein relates to the period from initiation of post-weaning (day 1) to about day 10 of post-weaning.

The term “phase 2” as used herein relates to the period from about day 11 to about day 22 of post-weaning. The end of Phase 2 can vary and is generally the end of the critical period of weaning of the PW piglets.

The term “phase 3” as used herein relates to the period from end of Phase 2, e.g., about day 23 to until the start of the fattening phase (about day 35 of post-weaning).

The term “critical period” relates to the period after weaning when the piglets are most susceptible to disease and mortality. The critical period is generally about 14 days post-weaning.

The term “phytogenic” as used herein relate to plant-derived herbs, spices or extracts and/or bioactive compounds found in plants. Phytogenic includes natural products directly derived from plants. Phytogenic also includes synthetic and/or nature-identical compounds/compositions that can be made artificially but are in their chemical composition identical to molecules found in plants. Phytogenic also includes synthetic and/or nature-identical compositions that are formed by combining or formulating individual components, natural and/or synthetic components, to form a composition that is found naturally. The present description will refer to plant-derived compounds, but it will be understood that synthetic/nature-identical compounds or compositions may also be used.

The term “phytogenic composition” as used herein relates to a composition comprising an essential oil core and may also include additives. Additives can include an encapsulation matrix, carriers, e.g., maltodextrin and the like. The phytogenic compositions described herein are standardized, specific and science-based combinations of bioactive compounds found in plants with proven efficacy and a sustainable impact on animals, people, and/or the environment. The phytogenic composition is combined or included in the drinking water of the PW piglets.

The term “plants” and plant derivatives” as used herein relates to any portion of a growing plant, including the roots, stems, stalks, leaves, branches, seeds, flowers, fruits, and the like.

The term “essential oil mixture” or “essential oils” as used herein relates to an essential oil or a combination of essential oils in an essential oil core. The essential oil core of the phytogenic composition preferably includes at least 2 essential oils. Essential oils and essential oil mixture will be used interchangeably. “Essential oils” as used herein relates to aromatic, volatile liquids extracted from plant material. Essential oils are often concentrated hydrophobic liquids containing volatile aroma compounds. Essential oil chemical constituents can fall within a wide range of chemical classes such as terpenes, terpenoids, phenols, aldehydes, ketones and phenylpropanoids. Essential oils can be natural (i.e., derived from plants), synthetic or a combination to achieve a nature identical essential oil.

The term “essential oil core” as used herein relates to an essential oil or a mixture of essential oils that are included and further includes additives such as encapsulation matrix, carriers, e.g., maltodextrin and the like. One or more of the essential oils may be microencapsulated with an encapsulation matrix and/or combined with a carrier to form the essential oil core. The essential oils may comprise, for example, eugenol and tea tree oil.

The term “eugenol” as used herein relates to 2-methoxy-4-prop-2-enylphenol which can be derived from plants, synthetically produced or a combination to achieve a nature identical eugenol. Eugenol can be derived from, for example, clove (Syzygium aromaticum), nutmeg (Myristica fragrans), cinnamon (Cinnamomum verum), basil (Ocimum basilicum), and/or bay leaf (Laurus nobilis). Eugenol derived from other plants can also be used and is also within the scope of this disclosure.

The term “tea tree oil” as used herein relates to an essential oil composed of mainly terpinene-4-ol ([1S]-4-methyl-1-propan-2-ylcyclohex-3-en-1-ol) and γ-terpinene (1-methyl-4-propan-2-ylcyclohexa-1,4-diene) which can be derived from plants, for example from Melaleuca alternifolia. “Tea tree oil” also can be composed of synthetically produced terpinene-4-ol and γ-terpinene or a combination of natural and synthetic terpinene-4-ol and γ-terpinene. “Tea tree oil” also includes nature-identical compositions with one or more natural or synthetic components found in tea tree oil combined to achieve the function of tea tree oil. Essential oils derived from other plants and composed mainly of terpinene-4-ol and γ-terpinene can also be used and are also within the scope of this disclosure. Tea tree oil as used herein includes about 50 to 80% terpinene-4-ol ([1S]-4-methyl-1-propan-2-ylcyclohex-3-en-1-ol) and γ-terpinene (1-methyl-4-propan-2-ylcyclohexa-1,4-diene).

The term “basal feed” as used herein relates to feed that is fed to the PW piglets during the post-weaning period. It includes the ingredients and nutrients needed for the PW piglets. Basal feed does not include the phytogenic compositions.

The term “PW piglet drinking water” or “piglet drinking water” or “phytogenic drinking water” as used herein relates to drinking water supplemented with a phytogenic composition.

In one aspect, the present description comprises a method of production of livestock animals, e.g., PW piglets, in a nursery. The method improves the performance of the livestock animals. The method includes providing drinking water supplemented with a phytogenic composition to the animals at the initiation of weaning. The animal is preferably a piglet, more preferably a PW piglet. The PW piglet is at least 10 days old, at least 15 days old, at least 17 days old, at least 19 days old, preferably at least 21 days old, or more preferably at least 23 days old, or more preferably between 21 days and 25 days old at the initiation of the method described herein of providing phytogenic drinking water. The method of providing phytogenic drinking water may also be initiated when the PW piglets are older than 25 days old.

In one aspect, the present description comprises a phytogenic composition for inclusion in the drinking water of PW piglets in a nursery. The phytogenic compositions included in the drinking water comprise an essential oil core. The phytogenic composition further comprises one or more additives, e.g., maltodextrin. The essential oil core may include an essential oil or a mixture of essential oils, e.g., a combination of preferably at least two essential oils. The phytogenic composition can include additives such as encapsulation materials, carriers and the like.

The essential oil core preferably includes a mixture of at least two essential oils. The essential oil core may include more than two essential oils. A variety of combinations of essential oils can be used in the essential oil core. The essential oil mixtures may comprise, for example, carvacrol, cinnamaldehyde, eugenol, trans-anethole, terpinene-4-ol, γ-terpinene, diallyl disulfide, diallyl trisulfide, D-limonene, and combinations thereof. In one aspect, essential oils included in the essential oil core comprise eugenol and tea tree oil.

The essential oil core of the phytogenic composition can comprise a mixture of essential oils, preferably one or more of the essential oils in the essential oil core are microencapsulated. The phytogenic composition may comprise an essential core wherein all of the essential oils are microencapsulated. The essential oils may be microencapsulated individually and then combined to form the essential oil core. Alternatively, the essential oils may be combined prior to microencapsulation. The essential oil core may comprise one microencapsulated essential oil and one essential oil that has not been microencapsulated. Microencapsulation of essential oils is known in the art and can be performed, for example, as described in EP U.S. Pat. No. 1,419,811A1, incorporated herein by reference. Other methods of encapsulation may also be used and are within the scope of this description.

The phytogenic compositions described herein may further comprise one or more additives. The additives can be soluble in water and/or enhance the solubility of the essential oils in water. The additives may be a liquid or a powder. Preferably, the one or more additives are soluble and/or dispersible in water. The one or more additives may comprise carriers. Carrier(s) can be combined with the essential oil core and/or the essential oils to form the phytogenic composition. Carriers included in the phytogenic composition may include, for example, starch hydrolysates, such as dextrins, maltodextrins, starches, modified starches, gum arabic alginates, natural resins, such as shellac, wood rosin, cellulose derivatives, such as hydroxypropyl cellulose sodium carboxylcellulose, methylcellulose, ethylcellulose, animal and/or vegetable proteins or their hydrolysates, such as gelatin, collagen, egg protein, wheat protein, caseinates, milk protein, soy protein, pea protein, soluble fibers (pectins) and/or mixtures thereof may be used. In one aspect, the phytogenic composition comprises maltodextrin combined with the essential oil core.

Additives can also comprise components present in an encapsulation matrix. Essential oil core can include essential oils combined in an encapsulation matrix. The essential oils can be combined with the encapsulation matrix during a microencapsulation process. A variety of the additives may be used in the encapsulation matrix during the microencapsulation process, during the formation of the essential oil core and/or during the formation of the phytogenic composition. Encapsulation matrix may also include natural polymers such as starch, maltodextrin, glucose-fructose syrup, proteins such as wheat and yeast protein, citric acid, and the like.

In one aspect, the essential oil core in the phytogenic composition comprises eugenol and tea tree oil. In one aspect, the phytogenic composition consists essentially of eugenol and tea tree oil as the essential oils. By consists essentially of, it is meant that the phytogenic composition may not include any other essential oils except eugenol and tea tree oil.

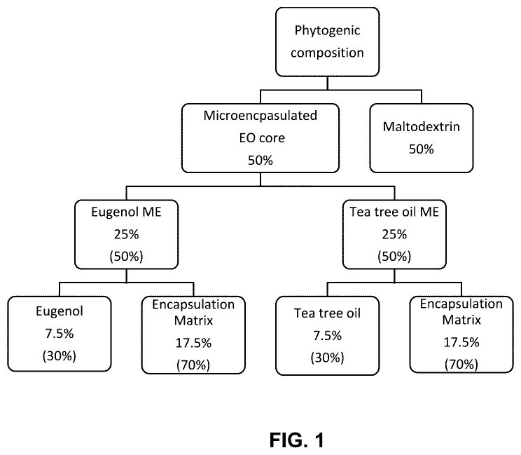

The phytogenic composition comprises microencapsulated essential oils wherein the eugenol and the tea tree oil are microencapsulated with an encapsulation matrix and combined with maltodextrin to form an essential oil core as shown in FIG. 1. Alternatively, eugenol and/or tea tree oil may be mixed prior to microencapsulation.

The amount of eugenol is between 20% by weight and 80% by weight of the total essential oils in the composition, preferably between 20% by weight and 60% by weight, preferably between 30% by weight and 70% by weight, more preferably between 30% by weight and 60% by weight, more preferably between 40% by weight and 60% by weight, more preferably between 45% by weight and 55% by weight, more preferably between 48% by weight and 52% by weight, more preferably between 49% by weight and 51% by weight, more preferably about 50% by weight of the total essential oils in the composition.

The amount of tea tree oil is between 20% by weight and 80% by weight of the total essential oils in the composition, preferably between 20% by weight and 60% by weight, preferably between 30% by weight and 70% by weight, more preferably between 30% by weight and 60% by weight, more preferably between 40% by weight and 60% by weight, more preferably between 45% by weight and 55% by weight, more preferably between 48% by weight and 52% by weight, more preferably between 49% by weight and 51% by weight, more preferably about 50% by weight of the total essential oils in the composition.

The ratio of the eugenol to tea tree oil in the phytogenic composition is between 5:1 and 1:5, preferably between 4:1 and 1:4, more preferably between 3:1 and 1:3, more preferably between 2:1 and 1:2, more preferably about 1:1.

The amount of essential oils in the phytogenic composition, e.g., eugenol and tea tree oil, is between about 5% by weight and about 40% by weight of the phytogenic composition, preferably between about 5% by weight and about 30% by weight, preferably between about 5% by weight and about 25% by weight, more preferably between about 5% by weight and about 20% by weight, more preferably between about 10% by weight and about 40% by weight, more preferably between about 10% by weight and about 30% by weight, more preferably between about 10% by weight and about 20% by weight, more preferably between about 12% by weight and about 18% by weight, more preferably between about 14% by weight and about 16% by weight, more preferably about 15% by weight of the phytogenic composition.

The amount of eugenol in the phytogenic composition is between about 2% by weight and about 30% by weight, preferably between about 5% by weight and about 20% by weight, more preferably between about 5% by weight and about 15% by weight, more preferably between about 5% by weight and about 10% by weight, more preferably between about 6% by weight and about 9% by weight, more preferably between about 7% by weight and about 8% by weight, more preferably about 7.5% by weight of the phytogenic composition.

The amount of tea tree oil in the phytogenic composition is between about 2.5% by weight and about 30% by weight, preferably between about 5% by weight and about 20% by weight, more preferably between about 5% by weight and about 15% by weight, more preferably between about 5% by weight and about 10% by weight, more preferably between about 6% by weight and about 9% by weight, more preferably between about 7% by weight and about 8% by weight, more preferably about 7.5% by weight of the phytogenic composition.

The phytogenic composition comprises a microencapsulated essential oil core in an amount of at least about 20% by weight, preferably at least about 30% by weight, preferably at least about 40% by weight, preferably at least about 45% by weight, preferably at least about 50% by weight of the composition. The phytogenic composition comprises a microencapsulated essential oil core of at an amount between about 20% by weight and about 80% by weight, preferably between about 30% by weight and about 70% by weight, preferably between about 40% by weight and about 60% by weight, preferably between about 45% by weight and about 55% by weight, preferably about 50% by weight of the composition.

The amount of one or more additives in the phytogenic composition can vary. In one aspect, the phytogenic composition may comprise maltodextrin as an additive. The amount of additive can be in an amount of at least about 20% by weight, preferably at least about 30% by weight, preferably at least about 40% by weight, preferably at least about 45% by weight, preferably at least about 50% by weight of the composition. The phytogenic composition may comprise an additive at an amount between about 20% by weight and about 80% by weight, preferably between about 30% by weight and about 70% by weight, preferably between about 40% by weight and about 60% by weight, preferably between about 45% by weight and about 55% by weight, preferably about 50% by weight of the composition.

The essential oil core may include essential oils or essential oil mixtures that are microencapsulated. The matrix for encapsulation may comprise modified starch and maltodextrins. The essential oils may be microencapsulated as indicated above. The amount of the encapsulation matrix in the microencapsulated essential oils can vary. The microencapsulated essential oil core may comprise encapsulation matrix of at least about 30% by weight, preferably at least about 40% by weight, preferably at least about 50% by weight, preferably at least about 60% by weight, preferably at least about 70% by weight of the microencapsulated essential oil core. The microencapsulated essential oil core may comprise essential oils in an amount of at least about 10% by weight, preferably at least about 20% by weight, preferably at least about 25% by weight, preferably at least about 30% by weight, by weight of the microencapsulated essential oil core.

In one aspect, the present description includes a powder phytogenic composition that can form a stable dispersion in liquids, e.g., in water. “Dispersion” as used herein relates to composition comprising dissolved components and dispersed components. The dispersed components can include dispersed liquid components and dispersed solid components and emulsions. Emulsions comprise a liquid/liquid dispersion. In other words, the powdered phytogenic composition that is combined with water to form the stock phytogenic composition and/or the phytogenic drinking water comprises a portion of the phytogenic composition that is soluble in the water, a portion that is particles suspended in the water, and a portion that is an emulsion in the water.

The phytogenic composition may be added to water or other liquid to form a stock phytogenic liquid. The stock phytogenic composition and the drinking water with the added stock phytogenic composition comprise a mixture of dispersed and dissolved components. The phytogenic composition is preferably dispersed in water but dispersion in other liquids is also within the scope of this description. Stock phytogenic liquid as used herein relates to the phytogenic composition dispersed in a liquid, preferably water, at a concentrated dose and will be referred to herein as the stock phytogenic composition. The stock phytogenic composition can be diluted to the desired concentration/dose by addition of the stock phytogenic composition with the drinking water to generate phytogenic drinking water. The phytogenic drinking water comprises the desired dose of the phytogenic composition. The phytogenic drinking water in a PW piglet nursery is further described below.

In one aspect, the phytogenic composition comprises a powder, a blended powder and/or other particulate composition. The phytogenic composition can be added to the liquid and mixed to disperse the composition into the water. Many mixing mechanisms are known in the art and any may be used to disperse the phytogenic composition in the drinking water. Any type of mixing mechanism may be used, e.g., a mixer, an agitator, a powered paint stirrer and the like. The phytogenic composition is dispersed in the water. The water with the phytogenic composition may result in a thin film at the bottom of the vessel without further mixing after about 3 hours, preferably after about 6 hours, preferably after about 10 hours, preferably after about 15 hours, preferably after about 20 hours.

The phytogenic composition may remain dispersed in the water for at least about 1 day, preferably at least about 2 days, preferably at least about 3 days, preferably at least about 4 days, preferably at least about 5 days, preferably at least about 6 days without stirring. It will be understood that minimal sedimentation may occur after about 4 days and stirring or mixing the composition can redisperse the phytogenic composition in the water.

The amount of the phytogenic composition in the stock phytogenic composition can vary and can be, for example, at least about 20 grams (g)/gallon (gal), preferably at least about 30 g/gal, preferably at least about 40 g/gal, preferably at least about 45 g, preferably at least about 48.4 g/gal. The amount of the phytogenic composition in the stock phytogenic composition can be between about 20 g/gal and about 80 g/gal, preferably between about 30 g/gal and about 70 g/gal, preferably between about 35 g/gal and about 62 g/gal, preferably between about 40 g/gal and about 57 g/gal, preferably between about 43 g/gal and about 53 g/gal, more preferably 48.4 g/gal. Stock phytogenic composition outside of this range may also be made and are within the scope of this description.

In another aspect, the present description includes drinking water with the phytogenic composition. The phytogenic composition is added to the water in the nursery to generate the desired concentration or dose of the phytogenic composition in the drinking water. A stock solution of the phytogenic composition can be added to the water to generate the desired concentration or dose of the phytogenic composition in the drinking water. Alternatively, the phytogenic composition may be added directly to the water. In one aspect, the stock phytogenic composition is combined with the drinking water at a dilution rate that can generate the desired concentration of the essential oils in the drinking water.

The dilution rate of the stock phytogenic composition into the water can vary. The stock phytogenic composition may be diluted at a ratio of 1:25 or more, preferably diluted at a ratio of 1:50 or more, preferably diluted 1:75 or more, preferably diluted 1:100 or more, preferably diluted 1:110 or more, preferably diluted 1:120 or more, preferably diluted at a ratio of 1:128 or more, preferably diluted at a ratio of 1:256 or more, preferably diluted at a ratio of 1:512 or more. Dilutions greater than 1:512 or also within the scope of this description.

The amount of phytogenic composition in the drinking water can be at a concentration between about 0.001 wt % and 0.1 wt % of the drinking water, preferably between about 0.005 wt % and about 0.05 wt %, preferably between about 0.0075 wt % and about 0.025 wt %, preferably between about 0.0085 wt % and about 0.015 wt %, preferably between about 0.009 wt % and about 0.012 wt %, preferably about 0.01 wt % of the drinking water.

The amount of phytogenic composition included in the phytogenic drinking water can be an amount between about 10 ppm and about 1000 ppm, preferably between about 50 ppm and about 500 ppm, more preferably between about 75 ppm and about 250 ppm, more preferably between about 85 ppm and about 150 ppm, and more preferably about 100 ppm.

The amount of eugenol included in the phytogenic drinking water can be an amount between about 1 ppm and about 30 ppm, preferably between about 3 ppm and about 20 ppm, more preferably between about 5 ppm and about 13 ppm, more preferably between about 7 ppm and about 9 ppm, and more preferably 7.5 ppm.

The amount of tea tree oil included in the phytogenic drinking water can be at an amount between about 1 ppm and about 30 ppm, preferably between about 3 ppm and about 20 ppm, more preferably between about 5 ppm and about 13 ppm, more preferably between about 7 ppm and about 9 ppm, and more preferably 7.5 ppm.

In one aspect, the present description includes a method for improving the performance of animals in a nursery, preferably PW piglets. The method includes providing drinking water supplemented with the phytogenic composition as described herein. The method can reduce the mortality rate of the PW piglets in a nursery relative to PW piglets that are not provided the phytogenic composition. The method may reduce the morbidity rate of PW piglets in a nursery relative to PW piglets that are not provided the phytogenic composition.

The method includes providing the phytogenic drinking water in a nursery with PW piglets. The PW piglets in the nursery are generally provided the phytogenic drinking water at the initiation of the PW period. At the initiation of the PW period, the PW piglets are at least 10 days old, preferably at least 15 days old, preferably at least 17 days old, preferably at least 19 days old, preferably at least 21 days old, or more preferably at least 23 days old, or more preferably between about 21 days and about 25 days old at the initiation of the method described herein with the phytogenic composition. The method of providing phytogenic drinking water may also be initiated when the PW piglets are older than 25 days old.

The weight of the PW piglets at the initiation of the PW period can vary. The PW piglets are at least 6 lbs, preferably at least 8 lbs, more preferably at least 9 lbs, more preferably at least 10 lbs and more preferably at least 11 lbs at the initiation of the method providing the phytogenic drinking water.

The method of providing the phytogenic drinking is initiated and/or provided to the PW piglets anytime during the PW period. The method described herein is provided to PW piglets between about day 10 and about day 75 of life. The method of providing phytogenic drinking water is preferably for at least the critical period, e.g., until 14 days PW, preferably at least until 22 days PW, preferably at least until 33 days PW. It will be understood that weaning times differ depending on the region and swine production systems, but the method described herein can be initiated as soon as piglets are weaned.

The method described herein is provided to PW piglets between about day 10 and about day 75 of life, preferably between days 15 and 70, preferably between days 18 and 70, preferably between days 18 and 60, preferably between days 18 and 50, preferably between days 18 and 45, preferably between days 21 and 70, more preferably between days 21 and 66, more preferably between days 21 and 60, more preferably between days 21 and 56, more preferably between days 21 and 50, more preferably between days 21 and 45, more preferably between days 23 and 75, more preferably between days 23 and 70, more preferably between days 23 and 66, more preferably between days 23 and 60, more preferably between days 23 and 50, more preferably between days 23 and 45, more preferably between days 25 and 75, more preferably between days 25 and 70, more preferably between days 25 and 66, more preferably between days 25 and 60, more preferably between days 27 and 70, more preferably between days 27 and 66, more preferably between days 27 and 60. The phytogenic drinking water is provided to PW piglets until at least day 31, preferably at least until day 42 of the PW piglets life.

The method comprises provided the phytogenic drinking water to PW piglets in a nursery for at least phase 1 and/or phase 2. Preferably, the phytogenic drinking water is provided in phase 1 and phase 2. The phytogenic composition is preferably provided in the drinking water after weaning (transition from milk feeding to cereal-based diets) and provided preferably for at least until about 10 days PW (throughout phase 1), preferably for at least until about 14 days PW (through the critical period), preferably for at least until about 22 days PW (throughout phase 1 and phase 2). The phytogenic composition may be provided after about 22 days PW (through all or part of phase 3). The phytogenic composition may be provided for any range between day 1 of PW and end of phase 3, preferably any range between day 1 PW to end of phase 2 (about day 22 to day 25), more preferably between day 1 PW to end of critical period (about day 14). It will be understood that weaning times differ depending on the region and swine production systems, but the method described herein can be initiated as soon as piglets are weaned.

The method comprises providing the drinking water with the phytogenic composition. The method can include combining the phytogenic composition with the water in the nursery to generate the desired concentration. A stock phytogenic composition can be combined with the water and diluted to generate a desired concentration of the phytogenic composition, e.g., about 0.01 wt %, in the drinking water. Preferably, the stock phytogenic composition is prepared daily for use in dilution, preferably within 24 hours of initiation of dilution into the drinking water, preferably within 12 hours of dilution, preferably within 6 hours of dilution, preferably within 4 hours of initiation of dilution. Alternatively, the phytogenic composition may be added directly to the water.

The phytogenic composition is combined with water at a rate that improves the performance of the PW piglets in the nursery. The inclusion amount of the phytogenic composition in the drinking water can be between about 0.001 wt % and 0.1 wt % of the drinking water, preferably between about 0.005 wt % and about 0.05 wt %, preferably between about 0.0075 wt % and about 0.025 wt %, preferably between about 0.0085 wt % and about 0.015 wt %, preferably between about 0.009 wt % and about 0.012 wt %, preferably about 0.01 wt % of the drinking water

The method may optionally include mixing or agitating the phytogenic drinking water to ensure that the phytogenic composition continues to be dispersed in the drinking water and to avoid settling of the phytogenic composition, preferably mixing or agitation is performed if the phytogenic composition has been added to the drinking water for about a day or longer. Mixing or agitation may not be necessary if the phytogenic composition has been combined in the drinking water for less than a day. In one aspect, the mixing or agitating may be performed to redisperse the phytogenic composition that has settled in the drinking water by a variety of mechanisms known in the art.

The method may include providing drinking water in a delivery method appropriate for the PW piglets such as a delivery device with a nipple for PW piglet suckling. Other delivery methods may be used and are within the scope of this description. The method may include combining water and a stock phytogenic composition, preferably with mixing, to maintain the desired levels of the phytogenic composition in the water delivery device. The stock phytogenic composition can be used to dose the appropriate amount into the drinking water in a PW piglet nursery.

The method includes providing eugenol and tea tree oil in the drinking water. The amount of eugenol provided in the drinking water can be an amount between about 1 ppm and about 30 ppm, preferably between about 3 ppm and about 20 ppm, more preferably between about 5 ppm and about 13 ppm, more preferably between about 7 ppm and about 9 ppm, and more preferably 7.5 ppm. The tea tree oil is included at an amount between about 1 ppm and about 30 ppm, preferably between about 3 ppm and about 20 ppm, more preferably between about 5 ppm and about 13 ppm, more preferably between about 7 ppm and about 9 ppm, and more preferably 7.5 ppm.

The method includes providing a basal feed to the PW piglets while the PW piglets are provided the phytogenic drinking water. The basal feed can vary. A variety of basal feeds are known in the art and appropriate for PW piglets. An example of basal feed for PW piglets formulated by Lindenberger Mühle, Germany, is disclosed in the Examples below. Basal feeds also include basal feed manufactured by Agropodnik Mašovice, a.s. in Mašovice, Czech Republic or by Purina, USA. Other basal feeds appropriate for PW piglets are within the scope of this disclosure. The basal feed may be supplemented with the phytogenic compositions described herein at the inclusion rates and doses disclosed.

The method may include providing the PW piglets ad libitum access to the feed. The method may include providing the PW piglets defined amounts of feed, e.g., not ad libitum access. Preferably, the method includes providing the PW piglets ad libitum access to the feed in a mash feed and/or pellet feed. Preferably, the method includes providing PW piglets feed in a mash feed. More preferably, the method includes providing the PW piglets ad libitum access to the feed in a pellet form.

The method of production of PW piglets in a nursery as described herein may, optionally, include separating PW piglets. The PW piglets of a smaller size may be separated from piglets that are average size or greater at the initiation of the PW period. PW piglets that develop a disease may be separated/removed from the PW piglets that are healthy and placed in a separate pen upon displaying symptoms of a disease. “Average pigs” referred to herein or PW piglets that are average in size, as known in the art, at the initiation of Phase 1 of the PW period and without symptoms of disease. In one aspect, the method may, optionally, include separating PW piglets that are less than about 10 lbs at day 1 of phase 1 from the average size PW piglets of about 10 lbs or greater. Other cutoffs for separation of average size piglets from small piglets may be used, for example, separating PW piglets less than about 9 lbs from piglets greater than or equal to 9 lbs, separating PW piglets less than about 11 lbs from piglets greater than or equal to 11 lbs and the like. The size/weight of the PW piglets that are separated can vary and all are within the scope of this description.

The separation of smaller piglets and/or piglets displaying disease symptoms enables more directed care in pens. PW piglets that are less than about 10 lbs will be referred to herein as “small PW piglets”, but it will be understood that the weight of the “small PW piglets” may vary and can be between, for example, between about 5 lbs and 12 lbs, or between 6 lbs and 11 lbs, or between 7 lbs and 11 lbs, or between 8 lbs and 11 lbs, or between 9 lbs and 11 lbs. PW piglets that display disease symptoms during the PW phase will be separated from the average PW piglets and/or the small PW piglets and placed in separate pens. The PW piglets that are removed because of disease will be referred to as “removals”. Removal pigs from the various treatments were moved to removal pens and were kept in the same water treatment.

The number of pigs/pen may vary and all are within the scope of this description. The method may comprise about at least 10 pigs/pen, preferably at least about 15 pigs/pen, preferably at least about 20 pigs/pen, preferably at least about 25 pigs/pen. The method may comprise greater than 25 pigs/pen as long as sufficient drinking water and feed are provided for the number of pigs in the pen.

The PW piglets have ad libitum access to the phytogenic drinking water in the pens. The amount of water consumed per pig can vary and generally increases with the increase of age and body weight. The amount of phytogenic drinking water consumed per pig can be between about 0.02 gal/pig/day and about 1 gal/pig/day, preferably between about 0.03 gal/pig/day and about 0.8 gal/pig/day. It will be understood that the amount of water consumed per pig will change as the piglets mature and increase as the body weight of the piglet increases. The amount of water provided can be increased as the weight of the piglets increases. Consumption of the phytogenic water outside of this range is also within the scope of this description.

The method described herein can improve the performance of the PW piglets. Improved performance characteristics of the PW piglets includes, for example, reduced mortality rate, reduced morbidity rate, enhanced growth, enhanced health and the like. The performance of the PW piglets can be improved by a reduction of the mortality rate in the nursery. The performance of the PW piglets can also improve a combination of the performance characteristics.

The method of the present description can reduce the closeout mortality rate of the PW piglets in a nursery. “Closeout mortality rate” as used herein is the mortality rate of the PW piglets at the end of the PW period (end of phase 3 (about day 35 of trial)). The closeout mortality rate of the combined PW piglets (of average size, small piglets and removal piglets) in the pens provided the phytogenic drinking water can be reduced by at least about 25%, preferably be at least about 30%, preferably at least about 35%, preferably at least about 40%, preferably at least about 45% by the end of the PW period relative to the mortality rate of PW piglets that were not provided the phytogenic drinking water. The mortality rate of the combined PW piglets (average size piglets, small PW piglets and removal piglets) in the pens provided the phytogenic drinking water is reduced to between about 25% and about 60%, preferably between about 30% and about 55%, preferably between about 35% and about 55%, preferably between about 40% and about 50%, preferably between about 45% and about 50% at the end of the PW period relative to the mortality rate of PW piglets that were not provided the phytogenic drinking water.

The method of the present description can reduce the closeout mortality rate of the average size PW piglets (without the small PW piglets) in a nursery relative to the control without the phytogenic drinking water. The closeout mortality rate of the average size PW piglets in the pens provided the phytogenic drinking water is reduced by at least about 25%, preferably by at least about 30%, preferably by at least about 35% relative to the mortality rate of the average size PW piglets that were not provided the phytogenic drinking water. The closeout mortality rate of the average size PW piglets provided the phytogenic drinking water is reduced by about 25% to about 60%, preferably by about 30% to about 55%, preferably by about 35% to about 55%, preferably by about 35% to about 50%, preferably by about 35% to about 45%, preferably by about 35% to about 40% relative to the mortality rate of average PW piglets that were not provided the phytogenic drinking water.

The method of the present description can reduce the closeout mortality rate of the small PW piglets (separated from the average size PW piglets) in a nursery relative to the control without the phytogenic drinking water. The closeout mortality rate of the small PW piglets in the pens provided the phytogenic drinking water is reduced by at least 25%, preferably by at least 30% relative to the mortality rate of PW piglets that were not provided the phytogenic drinking water. The closeout mortality rate of the small PW piglets provided the phytogenic drinking water is reduced by about 25% to about 50%, preferably by about 30% to about 55%, preferably by about 30% to about 40%, preferably by about 30% to about 35% relative to the mortality rate of PW piglets that were not provided the phytogenic drinking water.

The method of the present description can reduce the mortality rate of the combined PW piglets (average size piglets, small PW piglets and removal piglets) in a nursery by the end of phase 2 relative to the control without the phytogenic drinking water. The mortality rate of the combined PW piglets (average piglets and small piglets) at the end of phase 2 in the pens provided the phytogenic drinking water is reduced by at least about 20%, preferably by at least about 25%, preferably by at least about 30%, at the end of phase 2 of PW period relative to the mortality rate of PW piglets at the end of phase 2 that were not provided the phytogenic drinking water. The mortality rate of the PW piglets (average size piglets, small PW piglets and removal piglets) at the end of phase 2 in the pens provided the phytogenic drinking water is reduced by between about 25% and about 50%, preferably between about 30% and 55%, preferably between about 30% and about 45%, preferably between 30% and 40%, preferably between 35% and 40% at the end of phase 2 of the PW period relative to the mortality rate of PW piglets at the end of phase 2 that were not provided the phytogenic drinking water.

The method of the present description can reduce the mortality rate of the average size PW piglets (without small pigs) in a nursery after phase 2 relative to the control without the phytogenic drinking water. The mortality rate of the average PW piglets (without small pigs) at the end of phase 2 in the pens provided the phytogenic drinking water is reduced by at least about 25%, preferably by at least about 30% at the end of phase 2 of PW period relative to the mortality rate of PW piglets that were not provided the phytogenic drinking water. The mortality rate of the average size PW piglets (without small pigs) at the end of phase 2 in the pens provided the phytogenic drinking water is reduced by about 25% to about 50%, preferably by about 30% to about 55%, preferably by about 30% to about 45%, preferably by about 30% to about 40%, preferably by about 30% to about 35% at the end of phase 2 of the PW period relative to the mortality rate of PW piglets at the end of phase 2 that were not provided the phytogenic drinking water.

The method of the present description can enhance the health of the PW piglets. The method of the present description can reduce the morbidity of the PW piglets in a nursery. The method can reduce the number of removals of the PW piglets from the PW piglet pens provided the phytogenic drinking water compared to average PW piglet pens that were not provided phytogenic drinking water. The reduction in the number of removals can be at least one pig, or at least two pigs, or at least 3 pigs relative to the control.

The method of the present description can enhance the growth of the PW piglets. The method can contribute to increasing the average daily weight gain, final weight of the PW piglets.

Representative features of the present invention are set out in the following clauses, which stand alone or may be combined, in any combination, with one or more features disclosed in the text of the Specification.

The present invention is as set out in the following clauses:

Clause 1: A method of production of livestock animals in a nursery comprising:
providing drinking water supplemented with a phytogenic composition to post-weaning (PW) piglets, wherein the phytogenic composition comprises essential oils,
wherein the PW piglets have improved performance, the improved performance comprising a reduction in mortality rate in the nursery relative to PW piglets provided drinking water without the phytogenic composition.

Clause 2: The method of clause 1, wherein the essential oils comprise eugenol and tea tree oil.

Clause 3: The method of any one of the preceding clauses, wherein the phytogenic composition comprises between about 5% by weight and about 40% by weight of the essential oils.

Clause 4: The composition of any one of the preceding clauses, wherein the phytogenic composition comprises about 15% by weight of the essential oils.

Clause 5: The method of any one of the preceding clauses, wherein the phytogenic composition comprises between about 3% by weight and about 20% by weight of the eugenol and between about 3% by weight and about 20% by weight of the tea tree oil.

Clause 6: The method of any one of the preceding clauses, wherein the phytogenic composition comprises about 7.5% by weight of the eugenol and about 7.5% by weight of the tea tree oil.

Clause 7: The method of any one of the preceding clauses, wherein the phytogenic composition is included in the water at a concentration between about 0.005% to 0.1% by weight.

Clause 8: The method of any one of the preceding clauses, wherein the phytogenic composition is included in the water at a concentration of 0.01% by weight.

Clause 9: The method of any one of the preceding clauses, wherein the phytogenic composition further comprises an additive.

Clause 10: The method of any one of the preceding clauses, wherein the phytogenic composition comprises an additive and the additive comprises maltodextrin.

Clause 11: The method of any one of the preceding clauses, wherein the essential oils are microencapsulated in an encapsulation matrix.

Clause 12: The method of any one of the preceding clauses, wherein the drinking water with the phytogenic composition is provided for at least 10 days post weaning.

Clause 13: The method of any one of the preceding clauses, wherein the drinking water with the phytogenic composition is provided for at least 14 days post weaning.

Clause 14: The method of any one of the preceding clauses, wherein the PW piglets in the nursery with the phytogenic composition in the drinking water have a mortality rate reduced by at least 25% relative to the PW piglets in a nursery without the phytogenic composition in the drinking water.

Clause 15: The method of any one of the preceding clauses, wherein the PW piglets in the nursery with the phytogenic composition in the drinking have a mortality reduced by at least 35% relative to the PW piglets in a nursery without the phytogenic composition in the drinking water.

Clause 16: The method of any one of the preceding clauses, wherein the PW piglets comprise average size PW piglets, small PW piglets, or a combination thereof.

Clause 17: The method of any one of the preceding clauses, wherein the method further comprises separating PW piglets, wherein separating PW piglets comprises separating the small PW piglets from the average size PW piglets at the initiation of the PW period, separating PW piglets that display symptoms of disease during the PW period from healthy piglets or a combination thereof.

Clause 18: The method of any one of the preceding clauses, wherein the improved performance further comprises reduced morbidity, enhanced growth, enhanced health or combinations thereof of the PW piglets in the nursery.

Clause 19: A phytogenic drinking water composition comprising:
drinking water; and
a phytogenic composition, wherein the phytogenic composition comprises essential oils, wherein PW piglets in a nursery provided drinking water with the phytogenic composition have a reduced mortality rate relative to PW piglets provided drinking water without the phytogenic composition.

Clause 20: The composition of clause 19, wherein the essential oils comprise eugenol and tea tree oil.

Clause 21: The composition of clauses 19-20, wherein the phytogenic composition further comprises one or more additives.

Clause 21: The composition of clauses 19-21, wherein the phytogenic composition comprises between 5% by weight and 40% by weight of the essential oils.

Clause 23: The composition of any one of clauses 19-22, wherein the phytogenic composition comprises about 15% by weight of the essential oils.

Clause 24: The composition of clauses 19-23, wherein the phytogenic composition comprises between 3% by weight and 20% by weight of the eugenol.

Clause 25: The composition of clauses 19-24, wherein the phytogenic composition comprises about 7.5% by weight of the eugenol.

Clause 26: The composition of clauses 19-25, wherein the phytogenic composition comprises between 3% by weight and 20% by weight of the tea tree oil.

Clause 27: The composition of clauses 19-26, wherein the phytogenic composition comprises about 7.5% by weight of the tea tree oil.

Clause 28: The composition of clauses 19-27, wherein the phytogenic composition is included in the water at a concentration between about 0.005% to 0.1% by weight.

Clause 29: The composition of clauses 19-28, wherein the phytogenic composition is included in the water at a concentration of 0.01% by weight.

Clause 30: The composition of clauses 19-29, wherein the one or more additives comprises maltodextrin.

Clause 31: The composition of clauses 19-30, wherein the essential oils are microencapsulated in an encapsulation matrix.

Clause 32: The composition of clauses 19-31, wherein the drinking water with phytogenic composition is provided to the piglets for at least 14 days post weaning.

Clause 33: The composition of clauses 19-32, wherein the drinking water with phytogenic composition is provided to the piglets for at least 21 days post weaning.

Clause 34: The composition of clauses 19-33, wherein the PW piglets in the nursery with the phytogenic composition in the drinking have a mortality reduced by at least 25% relative to the PW piglets in a nursery without the phytogenic composition in the drinking water.

Clause 35: The composition of clauses 19-34, wherein the PW piglets in the nursery with the phytogenic composition in the drinking have a mortality reduced by at least 35% relative to the PW piglets in a nursery without the phytogenic composition in the drinking water.

Clause 36: The composition of clauses 19-35, wherein the PW piglets in the nursery with the phytogenic composition in the drinking have a mortality reduced by at least 40% relative to the PW piglets in a nursery without the phytogenic composition in the drinking water by about 42 days post-weaning.

Clause 37: A phytogenic composition comprising an essential oil core and one or more additives, wherein the essential oil core comprises essential oils, wherein the essential oils comprise eugenol between about 5% by weight and about 15% by weight of the phytogenic composition and tea tree oil between about 5% by weight and about 15% % by weight of the phytogenic composition.

Clause 38: The composition of clause 37, wherein the phytogenic composition comprises eugenol at 7.5% by weight.

Clause 39: The composition of clauses 37-38, wherein the phytogenic composition comprises tea tree oil at 7.5% by weight.

Clause 40: The composition of clauses 37-39, wherein the composition is included in water at a concentration between about 0.005% to 0.1% by weight.

Clause 41: The composition of clauses 37-40, wherein the composition is included in the water at a concentration of about 0.01% by weight.

Clause 42: The composition of clauses 37-41, wherein the one or more additives comprise maltodextrin.

Clause 43: The composition of clauses 37-42, wherein the composition comprises the polymer between about 25% by weight and about 75% by weight.

Clause 44: The composition of any one of clauses 37-43, wherein the eugenol and the tea tree oil are microencapsulated.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Evaluation of Water Supplementation

### Materials and Methods:

The study included 2,062 weaned pigs in 92 pens, e.g. 22 pigs/pen. The pigs were randomly placed into pens not accounting for sex. There were 23 replicate pens/treatment. The production period was 12-40 lbs. Treatments were applied to pigs between 12-26 lbs. A common diet for all the pigs was fed in phase 3.

There were four treatments:
Treatment A: Plain water (Control)
Treatment B: Water supplemented with phytogenic composition as shown in FIG. 1.

The composition includes 7.5% of eugenol and 7.5% of tea tree oil. Eugenol and tea tree oil are microencapsulated according to the process described in as described in EP U.S. Pat. No. 1,419,811A1. The additive maltodextrin is included as a carrier in the phytogenic composition.
Treatment C: Water supplemented with postbiotic liquid prototype 1
Treatment D: Water supplemented with postbiotic liquid prototype 2

The phytogenic composition used is shown in FIG. 1. The amount of the phytogenic composition is described below.

PL1 and PL2 are 2 prototypes of lactobacillus based postbiotic formulations to support the PW piglets.

Animals were placed as follows:
General population: n=20 pens per treatment; Pigs/pen=22-23;
Total pens=80; Total pigs=1,800; Initial BW=11.8 lb;
Mixed sex and weight pens; Pigs randomly allotted to pens
Small Pens: n=3 pens per treatment; Pigs/pen=21-23;
Total pens=12; Total pigs=262; Initial BW=8.5 lb;
Mixed sex and weight pens; Pigs randomly allotted to pens

Table 1 shows the characteristics of each of the phases.

TABLE 1

| | Phase 1 | Phase 2 | Phase 3 |
|---|---|---|---|
| BW, lb | 11-15 | 15-24 | 26-41 |
| Days of trial (Approx) | 0-10.5 | 10.5-21 | 21-35 |
| Diets | 4 Treatment | 4 Treatment | Common |
| | Diets | Diets | Diet |
| Feed medications | Mecadox 50 | DEN/CTC | None |
| Water medications | None | None | Amoxi/Naxcel |

Water medications were on hold for first 21 days of trial while water treatments were provided. After day 21 of trial, all treatments including control were administered the water medications. Amoxicillin was administered on days 22-27 after initiation of trial and Naxcel was administered between days 26 and days 32 after the initiation of trial.

Treatments (20 reps/TRT):

### Control (Plain Water)

Water supplemented with phytogenic prototype—0.01% in water “intake”/pig/day
Water supplemented with postbiotic prototype 1—0.0385% (0.04%) in water “intake”/pig/day
Water supplemented with postbiotic prototype 2—0.0773% (0.08%) in water “intake”/pig/day

Diets: All water treatments were fed same commercial diets during phase 1 and 2, and fed common phase 3 diet.

Duration: Water supplements were given from d 0-21 postweaning.

Water Medications: On hold for first 21 d on trial.

Table 2 shows the diets for phase 1 and phase 2.

TABLE 2

| Ingredient, % | Phase 1¹ | Phase 2² |
|---|---|---|
| Corn | 39.5 | 50.2 |
| SBM | 22.5 | 30.0 |
| Whey Permeate | 13.6 | 6.8 |
| HP 300 | 6.9 | 3.5 |
| Oats | 5.0 | 10.0 |
| Fat Liquid | 2.5 | 2.5 |
| Bovine Plasma | 2.0 | 0.0 |
| Soybean Hull | 1.5 | 1.5 |
| BioLys 77 | 0.54 | 0.57 |
| Mecadox | 0.25 | 0.0 |
| CTET | 0.0 | 10.22 |
| Denagard | 0.0 | 0.18 |

¹The following ingredients were included in the phase 1 diet: Sugar, Monocalcium phosphate, Calcium carbonate, Provimi premix, Salt, Zinc oxide, Benzoic acid, DL-Met, L-Thr, L-Val, L-Trp, Akey Milk Replacer, Choline Chloride, B-vitamin Premix, Pig request 50, Ethoxyquin, Natuphos E
²The following ingredients were included in the ph 2 diet: Monocalcium phosphate, Calcium carbonate, Provimi premix, Salt, Zinc oxide, Benzoic acid, DL-Met, L-Thr, L-Val, L-Trp, Vit E, Choline Chloride, Potassium Chloride, B-vitamin Premix, Pig request 50, Ethoxyquin, Natuphos E.

Table 3 shows the formulated values for Phase 1 and phase 2 diets.

TABLE 3

| Nutrient | Phase 1¹ | Phase 2² |
|---|---|---|
| CP, % | 20.43 | 20.1 |
| Fat, % | 4.5 | 4.6 |
| Ca, % | 0.7 | 0.7 |
| Dig P, % | 0.40 | 0.38 |
| SID Lys, % | 1.37 | 1.35 |
| SID M + C/Lys, % | 0.60 | 0.60 |
| SID Thr/Lys, % | 0.63 | 0.63 |
| SID Trp/Lys, % | 0.20 | 0.20 |
| SID Val/Lys, % | 0.70 | 0.66 |
| SID Ile/Lys, % | 0.57 | 0.59 |
| CHO FRM, % | 12.8 | 13.9 |
| CHO STR, % | 2.7 | 3.0 |
| GUT FP, % | 1.5 | 1.5 |
| SW CNE, kcal/kg | 2386 | 2373 |

¹Zn = 3030 ppm; Cu = 126 ppm; Phytase = 1,134 FTU/kg
²Zn = 3000 ppm; Cu = 126 ppm; Phytase = 1,134 FTU/kg

Feed medications were provided as listed below in Table 4.

TABLE 4

| Phase | TRT | Drug | Source | g/ton | % of diet |
|---|---|---|---|---|---|
| 1 | A-D | Carbadox | Mecadox 96G/# | 50 | 0.278 |
| 2 | A-D | Tiamulin/ | Denagard 10/ | 35/400 | 0.175/0.22 |
| | | CTC | Aureo 90 | | |
| 3 | A-D | Non- | | | |
| | | Medicated | | | |

Statistical Analysis: All data were analyzed in R using procedures provided by the lme4, lmerTest and forestinventory packages.

Performance variables (average body weight, average daily gain (ADG), average daily feed intake (ADFI), and gain: feed ratio (G:F) were analyzed as a general linear model for general population (not including small pens).

Count data (health variables−mortality and removals) were analyzed as a probabilistic generalized mixed model specifying a binomial distribution with a logit link for entire population (including small pens).

Fixed effect was the treatment. Random effect was based on the location block and barn. Significance detected at: P<0.10>0.05=tendency; P<0.05=significant.

SEs reported are the greatest value from all levels of the factor of interest.

Contrasts tested the effect of: plain water vs. phytogenic prototype; plain water vs. postbiotic liquid prototype #1 (PL1) and plain water vs. postbiotic liquid prototype #2 (PL2).

Water disappearance and stock solution were monitored daily. Table 5 shows the gallons of stock solutions used and adjustment made in case of values were below or above the target amounts shown in Table 5.

TABLE 5

| Water | | | | | | |
|---|---|---|---|---|---|---|
| disappearance | | | | | | |
| (gallons/pig) | Days 1-5 | Days6-10 | Days 11-14 | Days 15-16 | Days 17-20/22-24 | Days 21/25 |
| Target | 0.15 | 0.25 | 0.33 | 0.4 | 0.5 | 0.6 |
| Adjust if | | | | | | |
| Below | 0.13 | 0.21 | 0.28 | 0.34 | 0.43 | 0.51 |
| Above | 0.17 | 0.29 | 0.38 | 0.46 | 0.58 | 0.69 |
| Prepared | | | | | | |
| Stock solution | | | | | | |
| (gallons/trt) | | | | | | |
| Target | 0.8 | 1.5 | 2 | 2 | 2.5 | 3 |
| Adjust if | | | | | | |
| Above | 0.68 | 1.28 | 1.70 | 1.70 | 2.13 | 2.55 |

Phase 1 Objective: The primary purpose of phase 1 was to determine the effects of water supplementation on performance and health of nursery pigs. There were 46 mixed sex pens on treatment (3 light block/treatment+20 average blocks/treatment). All diets contained Mecadox, 3030 ppm zinc (0.41% zinc oxide), and high levels of copper (126 ppm).

The smallest pigs were sorted into a light block. Piglets in pens with small pigs were gruel fed for 5 days after placement The remainder pigs were gate cut into mixed weight pens not accounting for the distribution of barrows and gilts within a pen. Pens contained 22 pigs (mixed sex) in a pen. Pens were weighed, blocked on location, and assigned to one of the 4 dietary treatments. Pen weight and feed consumption were recorded after assigned days on test. Scour scores were taken on day 3, 6, 12, 17, and 23 post-weaning. The feeding schedule for Treatments A-D was 1.81 kg/pig.

Phase 2 Objective: The primary purpose of phase 2 was to determine the effects of water supplementation on performance and health of nursery pigs. There were 46 mixed weight and mixed sex pens on treatment (3 light block/treatment+5 average blocks/treatment). All diets contained DEN/CTC and contained 3000 ppm zinc and high levels of copper (126 ppm). Pigs were fed the same dietary sequence as the previous phase. Pen weight and feed consumption were recorded after assigned days on test. The feeding schedule for Treatments A-D was 5.44 kg/pig.

Phase 3 Objective: The primary purpose of phase 3 was to evaluate carry over responses on performance of nursery pigs. There were 46 mixed weight and mixed sex pens on treatment (3 light block/treatment+20 blocks/treatment). All diets were non-medicated and contain high levels of copper (125 ppm). Pigs were fed a common diet. Phase three diet was fed until pigs were shipped to finishers. Pen weight and feed consumption were measured at the end of the trial.

Closeout mortalities are the pigs that died during the trial with addition of the pigs that were removed during the trial that end up dead. Removals are the pigs that were removed from the original pen due to health issues and were placed in another pen for extra care and monitoring. The removals contribute to the morbidity rate. Decrease in removal numbers relates to decrease in morbidity.

### Results

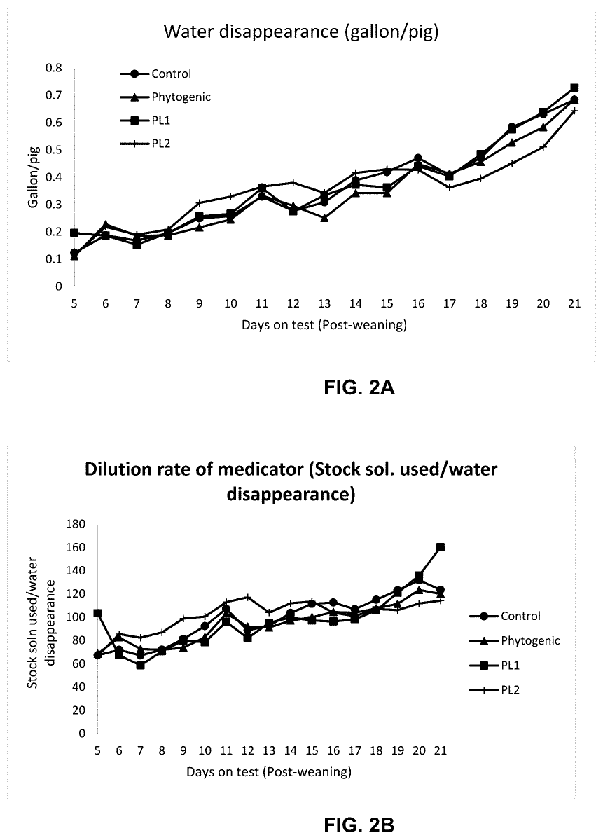

FIG. 2A is a plot of amount of water disappearance (gallons/pig) between day 5 and day 21 of the post-weaning period of the PW piglets. FIG. 2B is a plot of dilution ratio of medicator (stock solution used/water disappearance) between day 5 and day 21 of the post-weaning period of the PW piglets.

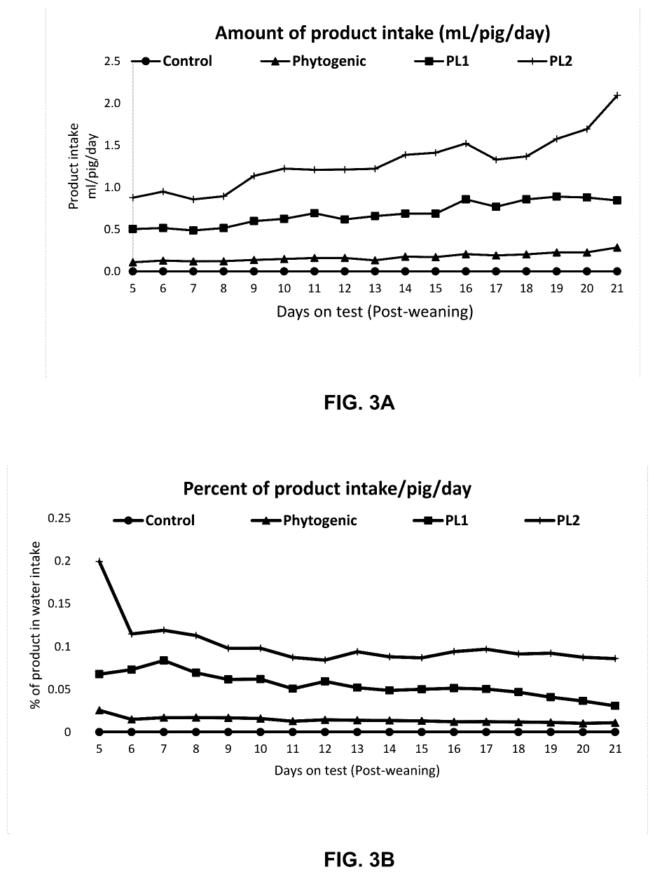

FIG. 3A is a plot of amount of product intake (mL/pig/day) between day 5 and day 21 of the post-weaning period of the PW piglets. FIG. 3B is a plot of percent of product intake between day 5 and day 21 the post-weaning period of the PW piglets.

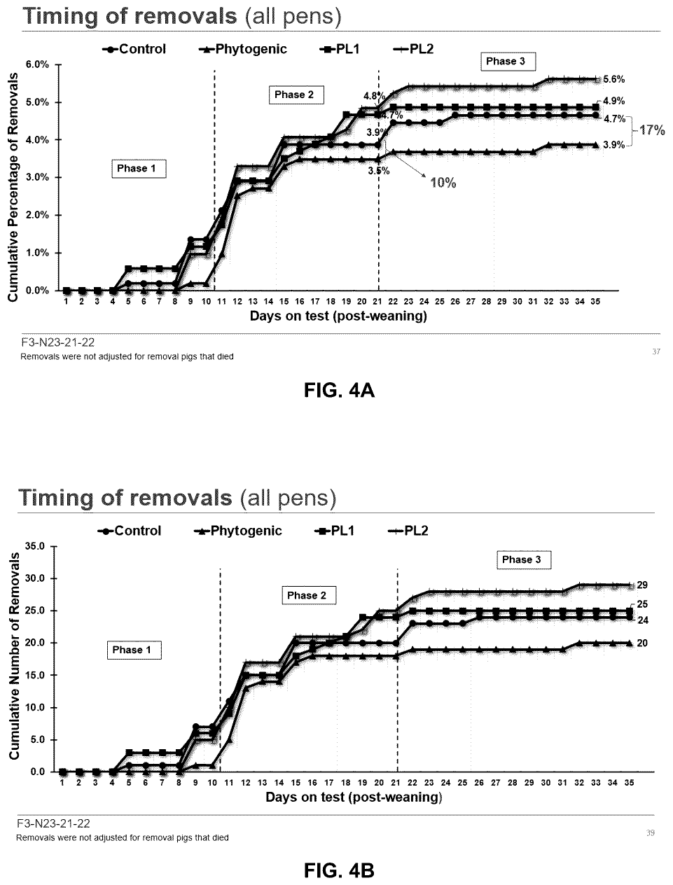

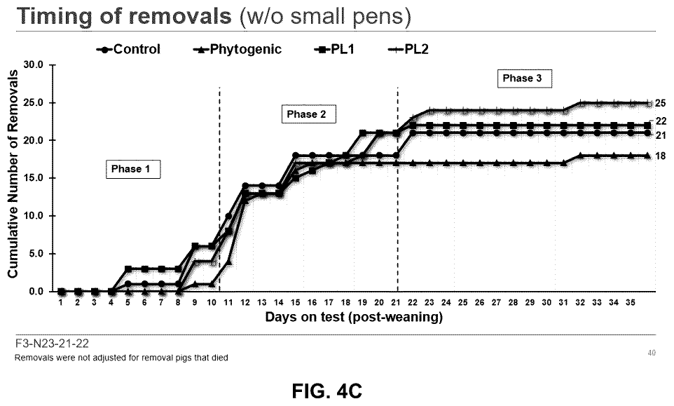

FIG. 4A is a plot of the timing of removals from all pens (average size and small PW piglet pens). The cumulative percentage of removals during the post-weaning period is shown. The cumulative percentage of removals were reduced by 10% after phase 2 and by about 17% by day 35. FIG. 4B is a plot of the timing of removals from all pens (average size and small PW piglet pens). The cumulative number of removals during the post-weaning period is shown. In this study, pigs that were removed and later died were not excluded in this visual graph. It was observed that there was 0.4% points reduction of removal pigs when pigs were supplemented the phytogenic in water compared to control pigs. This represents 10% removal pig reduction relative to control. Overall (at 35 days post-weaning), 0.8% points reduction of removal pig was observed when pigs were supplemented the phytogenic composition in the drinking water compared to control pigs. This represents 17% removal pig reduction relative to control. FIG. 4C is a plot of the timing of removals from the average size pig pens (without the small pig pens). The cumulative number of removals during the post-weaning period is shown. The cumulative percentage of removals were reduced by 10% after phase 2 and by about 14% by day 35.

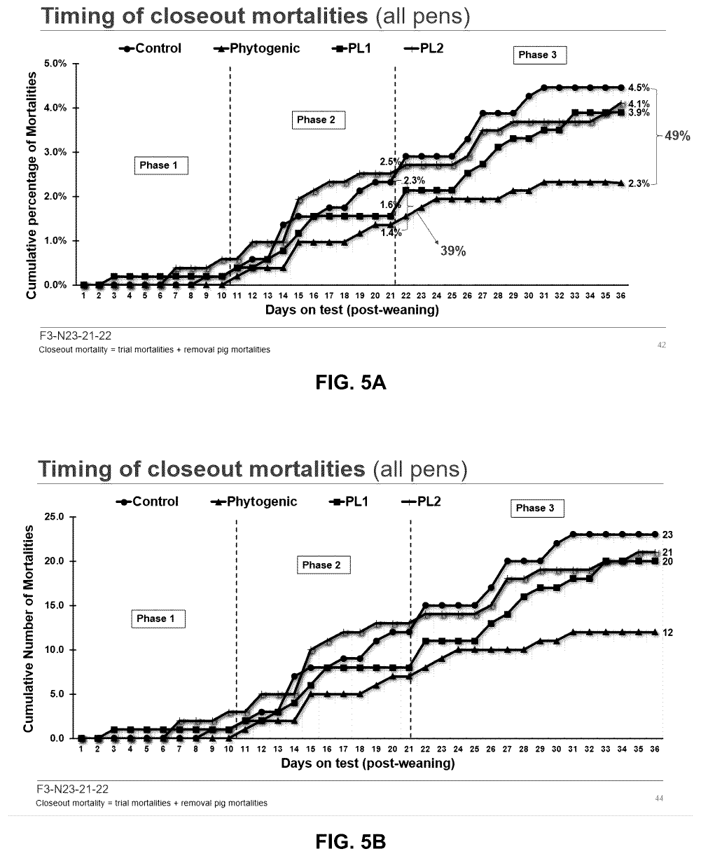

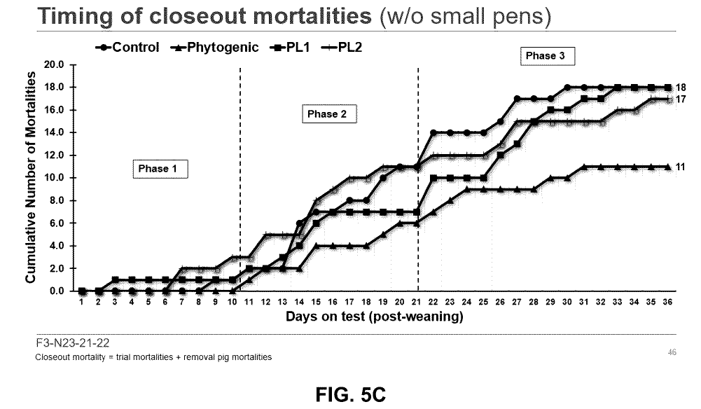

FIG. 5A is a plot of the timing of closeout mortalities (at day 36 or treatment) for all pens (average size, small PW piglet pens and removal pig mortalities). The cumulative percentage of mortalities during the post-weaning period is shown. The reduction in mortality after Phase 2 is about 39% and after Phase 3 is about 49% relative to the control. FIG. 5B is a plot of the timing of closeout mortalities (at day 36 or treatment) for all pens (average size, small PW piglet pens and removal pig mortalities). The cumulative number of mortalities during the post-weaning period is shown. FIG. 5C is a plot of the timing of closeout mortalities (at day 36 or treatment) from the average size pig pens (without the small pig pens). The cumulative number of mortalities during the post-weaning period is shown.

Table 6 shows the results of the mortality and removal after phase 1 and phase 2. The phytogenic drinking water reduced the mortality rate for all pens by 33% compared to the control (only water) at the end of phase 2. The phytogenic drinking water reduced the mortality rate in the average size pig pens by 33% compared to the control (only water).

TABLE 6

| Item for phase 1 and 2 | Control | Phytogenic | PL1 | PL2 |
|---|---|---|---|---|
| All pens | | | | |
| Total number of pigs | 516 | 517 | 515 | 517 |
| Number of pigs dead | 6 | 4 | 4 | 4 |
| Number of pigs removed | 20 | 18 | 24 | 25 |
| Mortality, % | 1.16 | 0.77 | 0.78 | 0.77 |
| Removals % | 3.88 | 3.48 | 4.66 | 4.84 |
| W/o small pig pens | | | | |
| Total number of pigs | 450 | 451 | 451 | 451 |
| Number of pigs dead | 6 | 4 | 4 | 4 |
| Number of pigs removed | 18 | 17 | 21 | 21 |
| Mortality, % | 1.33 | 0.89 | 0.89 | 0.89 |
| Removals % | 4.00 | 3.77 | 4.66 | 4.66 |
| Small pig pens only | | | | |
| Total number of pigs | 66 | 66 | 64 | 66 |
| Number of pigs dead | 0 | 0 | 0 | 0 |
| Number of pigs removed | 2 | 1 | 3 | 4 |
| Mortality, % | 0.00 | 0.00 | 0.00 | 0.00 |
| Removals % | 3.03 | 1.52 | 4.69 | 6.06 |

Table 7 shows the results of the mortality and removal at the end of phase 3 (day 35 of the trial). The phytogenic drinking water reduced the mortality rate by 48% compared to the control (only water) in the combined pig pens (average size piglet pens, small piglet pens, and pens with removals). The phytogenic drinking water reduced the mortality rate by 39% compared to the control (only water) in the average size pig pens (without small pigs).

TABLE 7

| | | Phyto- | | |
|---|---|---|---|---|
| Item | Control | genic | PL1 | PL2 |
| All pens | | | | |
| Total number of pigs | 516 | 517 | 515 | 517 |
| Number of pigs removed | 24 | 20 | 25 | 29 |
| Number of pigs removed that | 14 | 16 | 17 | 17 |
| remained alive (end of day 35) | | | | |
| Number of pigs dead after removal | 10 | 4 | 8 | 12 |
| Number of pigs dead from | 13 | 8 | 12 | 9 |
| healthy pens | | | | |
| Total number of closeout dead pigs | 23 | 12 | 20 | 21 |
| from healthy and sick pens | | | | |
| (end of day 35) | | | | |
| Closeout mortality, % (end of day 35) | 4.46 | 2.32 | 3.88 | 4.06 |
| Removals that remained alive | 2.71 | 3.09 | 3.30 | 3.29 |
| % (end of day 35) | | | | |
| W/o small pig pens | | | | |
| Total number of pigs | 450 | 451 | 451 | 451 |
| Number of pigs removed | 21 | 18 | 22 | 25 |
| Number of pigs removed that | 13 | 15 | 15 | 15 |
| remained alive (end of day 35) | | | | |
| Number of pigs dead after removal | 8 | 3 | 7 | 10 |
| Number of pigs dead from | 10 | 8 | 11 | 7 |
| healthy pens | | | | |
| Total number of closeout dead pigs | 18 | 11 | 18 | 17 |
| from healthy and sick pens | | | | |
| (end of day 35) | | | | |
| Closeout mortality, % (end of day 35) | 4.00 | 2.44 | 3.99 | 3.77 |
| Removals that remained alive % | 2.89 | | | |
| (end of day 35) | | 3.33 | 3.33 | 3.33 |
| Small pig pens only | | | | |
| Total number of pigs | 66 | 66 | 64 | 66 |
| Number of pigs removed | 3 | 2 | 3 | 4 |
| Number of pigs removed that | 1 | 1 | 2 | 2 |
| remained alive (end of day 35) | | | | |
| Number of pigs dead after removal | 2 | 1 | 1 | 2 |
| Number of pigs dead from | 3 | 0 | 1 | 2 |
| healthy pens | | | | |
| Total number of closeout dead pigs | 5 | 1 | 2 | 4 |
| from healthy and sick pens | | | | |
| (end of day 35) | | | | |
| Closeout mortality, % (end of day 35) | 7.58 | 1.52 | 3.13 | 6.06 |
| Removals that remained alive % | 1.52 | 1.52 | 3.13 | 3.03 |
| (end of day 35) | | | | |

Table 8 shows the fate of the removal pigs (removals) that were removed from the average size and small piglets when symptoms of disease were displayed. The number of removals that died after removal were lower when the removals were provided the phytogenic composition compared to removal provided only drinking water without the phytogenic composition.

TABLE 8

| Fate of removal pigs | Control | Phytogenic | PL1 | PL2 |
|---|---|---|---|---|
| All pens | | | | |
| Total number of removal pigs | 24 | 20 | 25 | 29 |
| Remained Alive | 14 | 16 | 17 | 17 |
| Fallback | 2 | 3 | 7 | 4 |
| Strep | 2 | 0 | 1 | 1 |
| Dead | 6 | 1 | 0 | 7 |
| W/o small pig pens | | | | |
| Total number of removal pigs | 21 | 18 | 22 | 25 |
| Remained Alive | 13 | 15 | 15 | 15 |
| Fallback | 2 | 2 | 6 | 3 |
| Strep | 1 | 0 | 1 | 1 |
| Dead | 5 | 1 | 0 | 6 |

Table 9 shows the growth performance date at the end of the phase 3 (day 35 of trial) compared to the initiation of trial (day 1). The total body weigh produced is the total amount of weight gain (lbs) by all the piglets in the pens.

TABLE 9

| | | Phyto- | | |
|---|---|---|---|---|
| | Control | genic | PL1 | PL2 |
| W/o small pig pens | | | | |
| (until day 35) | | | | |
| Initial weight, lb | 11.81 | 11.90 | 11.83 | 11.84 |
| Final weight, lb | 41.76 | 42.27 | 41.62 | 41.61 |
| ADGc, lb | 0.84 | 0.85 | 0.83 | 0.83 |
| ADFIc, lb | 1 | 1.02 | 1 | 1 |
| F:Gc | 1.19 | 1.19 | 1.2 | 1.21 |
| Injections, counts | 158 | 148 | 154 | 143 |
| Number of pigs alive | 432 | 440 | 433 | 434 |
| until end of trial | | | | |
| Total body weight | 18,040 | 18,599 | 18,021 | 18,059 |
| produced, lb | | | | |
| Small pig pens only | | | | |
| (overall until day 35) | | | | |
| Initial weight, lb | 8.43 | 8.33 | 8.64 | 8.49 |
| Final weight, lb | 35.06 | 36.07 | 34.62 | 36.55 |
| ADGc, lb | 0.744 | 0.783 | 0.724 | 0.789 |
| ADFIc, lb | 0.839 | 0.872 | 0.833 | 0.886 |
| F:Gc | 1.127 | 1.113 | 1.15 | 1.122 |
| Injections, counts | 26 | 29 | 38 | 39 |
| Number of pigs alive | 61 | 65 | 62 | 62 |
| until end of trial | | | | |
| Total body weight | 2,139 | 2,345 | 2,146 | 2,266 |
| produced, lb | | | | |

### SUMMARY

The phytogenic drinking water for all pigs as overall period (35 days) reduced closeout mortality by 49% and numerically reduced removal pigs by 17% compared to control group. For small pig pens, numerically reduced closeout mortality by 80% compared to control group.

What is claimed is:

1. A method of production of livestock animals in a nursery comprising:
providing drinking water supplemented with a phytogenic composition to post-weaning (PW) piglets, wherein the phytogenic composition comprises essential oils,
wherein the PW piglets have improved performance, the improved performance comprising a reduction in mortality rate in the nursery relative to PW piglets provided drinking water without the phytogenic composition.

2. The method of claim 1, wherein the essential oils comprise eugenol and tea tree oil.

3. The method of claim 1, wherein the phytogenic composition comprises between about 5% by weight and about 40% by weight of the essential oils.

4. The method of claim 1, wherein the phytogenic composition comprises between about 3% by weight and about 20% by weight of the eugenol and between about 3% by weight and about 20% by weight of the tea tree oil.

5. The method of claim 1, wherein the phytogenic composition is included in the water at a concentration between about 0.005% to 0.1% by weight.

6. The method of claim 1, wherein the drinking water with the phytogenic composition is provided for at least 10 days post weaning.

7. The method of claim 1, wherein the PW piglets in the nursery with the phytogenic composition in the drinking water have a mortality rate reduced by at least 25% relative to the PW piglets in a nursery without the phytogenic composition in the drinking water.

8. The method of claim 1, wherein the method further comprises separating PW piglets, wherein separating PW piglets comprises separating small PW piglets from average size PW piglets at the initiation of the PW period and separating PW piglets that display symptoms of disease during the PW period from healthy piglets or a combination thereof.

9. The method of claim 1, wherein the improved performance further comprises reduced morbidity, enhanced growth, enhanced health or combinations thereof of the PW piglets in the nursery.

10. A phytogenic drinking water composition comprising:
drinking water; and
a phytogenic composition, wherein the phytogenic composition comprises essential oils, wherein PW piglets in a nursery provided drinking water with the phytogenic composition have a reduced mortality rate relative to PW piglets provided drinking water without the phytogenic composition.

11. The composition of claim 10, wherein the essential oils comprise eugenol and tea tree oil.

12. The composition of claim 10, wherein the phytogenic composition comprises between 5% by weight and 40% by weight of the essential oils.

13. The composition of claim 10, wherein the phytogenic composition comprises between 3% by weight and 20% by weight of the eugenol.

14. The composition of claim 10, wherein the phytogenic composition comprises between 3% by weight and 20% by weight of the tea tree oil.

15. The composition of claim 10, wherein the phytogenic composition is included in the water at a concentration between about 0.005% to 0.1% by weight.

16. The composition of claim 10, wherein the phytogenic composition is included in the water at a concentration of 0.01% by weight.

17. The composition of claim 10, wherein the essential oils are microencapsulated in an encapsulation matrix.

18. A phytogenic composition comprising an essential oil core and one or more additives, wherein the essential oil core comprises essential oils, wherein the essential oils comprise eugenol between about 5% by weight and about 15% by weight of the phytogenic composition and tea tree oil between about 5% by weight and about 15% % by weight of the phytogenic composition.

19. The composition of claim 18, wherein the phytogenic composition comprises eugenol at 7.5% by weight and wherein the phytogenic composition comprises tea tree oil at 7.5% by weight.

20. The composition of claim 18, wherein the eugenol and the tea tree oil are microencapsulated.
